(19) United States
(12) Patent Application Publication
(10) Pub. No.: US 2009/0232372 A1
(43) Pub. Date: Sep. 17, 2009

(54) ADAPTIVE OVERLAPPING OF CARDIAC WEIGHTING VECTORS IN CARDIAC CT

(75) Inventors: Thomas Köhler, Norderstedt (DE); Roland Proksa, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 11/817,032

(22) PCT Filed: Feb. 13, 2006
(86) PCT No.: PCT/IB2006/050455

§ 371 Date: Aug. 24, 2007

(30) Foreign Application Priority Data
Feb. 24, 2005 (EP) 05101412.4

(51) Int. Cl. G06K 9/00

(52) U.S. Cl. 382/131

(57) ABSTRACT

A device (118) for analyzing multi-cycle cardiac computer tomography data detected by attenuating X-rays by a heart (130), comprising a first determining unit adapted to determine, based on the detected computer tomography data, a cardiac weighting function (302) for a reconstruction of an image of the heart (130), and a modifying unit adapted to modify the cardiac weighting function (302) in such a manner that an overlap of succeeding distribution functions (303) of the weighting function (302), which distribution functions (303) are assigned to different cycles of the heart (130), is at least equal to a predefined overlap threshold.

Device and method for analyzing multi-cycle cardiac computer tomography data, computer tomography apparatus, computer-readable medium and program element

The invention relates to the field of X-ray imaging. In particular, the invention relates to a device and to a method for analyzing multi-cycle cardiac computer tomography data, to a computer tomography apparatus, to a computer-readable medium and to a program element.

Computed tomography (CT) is a process of using digital processing to generate a three-dimensional image of the internals of an object under investigation from a series of two-dimensional X-ray images taken around a single axis of rotation. The reconstruction of CT images can be done by applying appropriate algorithms.

One important application in the frame of the computer tomography is so-called cardiac computer tomography which is related to the reconstruction of a three-dimensional image of a beating heart.

One key step in cardiac computer tomography is the selection of projections used for reconstruction. When an X-ray source and a detector mounted on a gantry rotate and detect detecting signals during a motion on a helical trajectory, then only a part of the captured data is selected in a retrospective analysis (that is after haven detected the data) for further use. Typically, the selection is performed such that as few projections as possible are used for reconstruction in order to optimize the temporary resolution of the image. However, one shortcoming of this approach is that artifacts may appear in the reconstructed image of the heart resulting from improper selection of data for further use and resulting from motion of the heart and of the patient during the detection of data.

Grass, M. et al. “Helical cardiac cone beam reconstruction using retrospective ECG gating”, Phys. Med. Biol. 48 (2003), pages 3069-3084 discloses so-called extended cardiac reconstruction (ECR). The ECR method integrates the idea of retrospectively gated cardiac reconstruction for helical data acquisition into a cone-beam reconstruction framework. It leads to an efficient and flexible algorithm scheme for the reconstruction of single-phase and multi-phase cardiac volume data sets.

ECR is an approximate helical cone beam reconstruction method based on a 3D filtered back projection. Within this cone-beam reconstruction framework, a retrospective cardiac gating scheme restricts the temporal information to a certain cardiac motion state of interest. The required high redundancy of the projection data is achieved by using a low pitch helical acquisition mode. From the full set of projection data a subset is selected to restrict the information integrated in the image volume to a defined motion state of the heart. This procedure is known as retrospectively gated cardiac reconstruction.

According to the ECR method, apart from geometric weighting factors, an illumination window dependent weighting factor of each voxel and a cardiac weighting factor are implemented.

The cardiac weighting function may be calculated from the patient's electrocardiogram (ECG) which may be acquired and used to determine the motion state of the heart. The cardiac weighting function determines the part of the projection data and the temporal domain, which is used to reconstruct an image volume for a certain cardiac phase. It restricts the input data for the reconstruction to a fixed motion state of the heart. Prior to back projection, the illumination weighting function and the cardiac weighting function may be combined for each voxel in the volume using a normalization approach.

The above-mentioned reference Grass et al. discloses in section 2.3 how to perform cardiac weighting. The cardiac weighting function selects some projection data from the low pitch helical acquisition which corresponds to a certain motion state of the heart. Retrospective cardiac gating is based on the assumption that the heart returns to the motion state in each cardiac cycle and essentially keeps this motion state for a certain duration. Since a heart performs a continuous motion over the cardiac cycle, a finite size of the cardiac gating window may lead to some remaining motion artifacts in the reconstruction volume. Another source for these artifacts may be a slight variation in the motion behaviour from cycle to cycle. However, a finite gating window size in combination with multi-cycle reconstruction is used in retrospectively gated helical cardiac cone beam CT in order to achieve proper temporal resolution at finite scan times.

The cardiac weighting function is characterized by different parameters which depend on the scan protocol and the patient's physiology. A first parameter is the phase point which determines the center of the gating window extracted from the patient's ECG. Two other parameters are the width and the shape of the gating window which depend on the scan parameters and the relation to the heart motion of the patient.

However, under unfavourable circumstances, the described extended cardiac reconstruction (ECR) method may be prone to artifacts in the reconstruction of the image of the heart, thus yielding a poor quality of the reconstructed image.

It would be desirable to improve the quality of the reconstructed image of a heart in the frame of cardiac CT.

This may be achieved by providing a device and a method for analyzing multi-cycle cardiac computer tomography apparatus, a computer tomography apparatus, a computer-readable medium and a program element having the features according to the independent claims.

According to an exemplary embodiment of the invention, a device for analyzing multi-cycle cardiac computer tomography data detected by X-rays attenuated by the heart (and the thorax) is provided. The device comprises a first determining unit adapted to determine, based on the detected computer tomography data, a cardiac weighting function for a reconstruction of an image of the heart. The device further includes a modifying unit adapted to modify the cardiac weighting function in such a manner that an overlap of succeeding distribution functions of the weighting function, which distribution functions are assigned to different cycles of the heart, is at least equal to a predefined overlap threshold.

According to another exemplary embodiment of the invention, a computer tomography apparatus is provided, comprising an X-ray source adapted to emit X-rays to a heart and adapted to rotate around the heart, detecting elements adapted to rotate around the heart and adapted to detect multi-cycle cardiac computer tomography data by detecting X-rays emitted by the X-ray source and attenuated by the heart, and a device having the above-mentioned features for analyzing the detected multi-cycle cardiac computer tomography data.

According to another exemplary embodiment of the invention, a method of analyzing multi-cycle cardiac computer tomography data detected by attenuating X-rays by a heart is provided, comprising the steps of determining, based on the detected computer tomography data, a cardiac weighting function for a reconstruction of an image of the heart. Further, the cardiac weighting function is modified in such a manner that an overlap of succeeding distribution functions of the weighting function, which distribution functions are assigned to different cycles of the heart, is at least equal to a predefined overlap threshold.

Beyond this, according to another exemplary embodiment of the invention, a computer-readable medium is provided, in which a computer program of analyzing multi-cycle cardiac computer tomography data detected by attenuating X-rays by a heart is stored which, when being executed by a processor, is adapted to carry out the above-mentioned method steps.

Furthermore, according to another exemplary embodiment of the invention, a program element of analyzing multi-cycle cardiac computer tomography data detected by attenuating X-rays by a heart is provided, which, when being executed by a processor, is adapted to carry out the above-mentioned method steps.

The analysis of multi-cycle cardiac computer tomography data according to the invention can be realized by a computer program, i.e. by software, or by using one or more special electronic optimization circuits, i.e. in hardware, or in hybrid form, i.e. by means of software components and hardware components.

The characterizing features of the invention particularly have the advantage that multi-cycle cardiac computer tomography data detected by attenuating X-rays by a heart may be analyzed in such a manner that artifacts may be efficiently suppressed or may even be completely avoided which results in an improved quality of a reconstructed image of the heart under investigation. This suppression of artifacts results from the fact that a cardiac weighting function determined for multi-cycle cardiac computer tomography data (that is cardiac computer tomography data detected during a plurality of cycles of the heart beat) are analyzed by verifying whether a variation of the motion state of the heart in different phases during the detection of data selectively used for the estimated cardiac weighting function varies in such a strong manner that motion artifacts may occur. Such disturbing motion may originate from the heart beat and/or from motion of the entire patient during the examination. In other words, particularly in case that it is determined that the motion state of the heart differs significantly in different projections which are selected via the estimated cardiac weighting function, then the cardiac weighting function is modified so that additional data are selected from the multi-cycle cardiac computer tomography data for a further analysis. This selection is performed in a manner that the correspondingly selected data/projections introduce less or no motion artifacts in the subsequent reconstruction. Therefore, this modification allows to reconstruct an image of the heart with a better quality.

According to an exemplary embodiment of the invention, a cardiac CT data set may be acquired by rotating X-ray source and detector around a heart of a human being. Based on this measurement, a plurality of projection data are obtained. Simultaneously, an electrocardiogram can be measured, wherein the data according to the electrocardiogram can later be used to select data which are appropriate for a subsequent reconstruction of the image of the heart, taking into account the beating cycles of the heart. After the measurement, that is retrospectively, appropriate data may be selected using the electrocardiogram signals, wherein the selected data are then used for a further examination.

The modifying unit of the system of the invention may modify the previously calculated cardiac weighting function so that an overlap of consecutive distribution functions (which may also be denoted as weighting vectors) of the weighting function is at least equal to a predefined overlap threshold. The distribution functions are usually assigned to different cycles of the heart. Thus, as will be explained below particularly referring to FIG. 7, the weighting function defines which projections will be used for the reconstruction of the image of the heart. When data from different heart cycles shall be used, then the weighting function can be divided into a plurality of weighting vectors, wherein each of the weighting vectors defines a distribution function determining which data related to an assigned heart cycle are selected for further analysis, and with which weighting factors. Accordingly, an “overlap” of weighting vectors or distribution functions is a value which defines the distance(s) between limits of adjacent weighting vectors. A large overlap relates to relatively broad adjacent distribution functions, that is a relatively small distance between adjacent weighting vectors. Generally, a sufficiently large value of the overlap corresponds to a relatively small probability for the occurrence of artifacts.

The data may be captured by a computer tomography apparatus having an X-ray source and a detector mounted on a gantry rotating in a helical manner around the heart. For each heart cycle, a part of the corresponding projections of source/detector with respect to the heart may be selected for the reconstruction of the image of the heart. Particularly when adjacent portions of used data of subsequent heart cycles relate to positions of source/detector with respect to the heart which essentially equal to a multiple of 180° (that is 180°, 360°, 540°, . . . ), the corresponding cardiac weighting function is prone to produce artifacts in the reconstructed image of the heart. These artifacts may be removed by changing the ranges of data/projections used for the further analysis, e.g. by enlarging the gating windows of distributions functions of the cardiac weighting function related to different heart cycles.

The invention may be realized in the frame of a helical cardiac cone beam reconstruction scheme using retrospective ECR (extended cardiac reconstruction) gating in a similar manner as disclosed in the above-mentioned reference Grass et al., but improving the obtainable image quality by removing artifacts which may occur according to the above-mentioned reference Grass et al. According to the invention, an adaptive overlapping of cardiac weighting vectors in the frame of cardiac CT may be carried out. The selection of projections used for reconstruction of the image of a heart of cardiac CT data may include only a defined part of the projections (preferably as few as possible) related to the captured data, so that the temporal resolution of the image can be improved. According to the invention, the appearance of artifacts in the reconstructed image is efficiently suppressed, since the invention allows to recognize and eliminate the origin of such artifacts.

It has been recognized by the inventors of the present invention that artifacts may particularly appear when the following three conditions are fulfilled in a cumulative manner.

Firstly, the patient heart rate has to allow for a multi-cycle reconstruction. In other words, artifacts may appear in the frame of a multi-cycle reconstruction scheme, since the consideration of data related to different cycles of the heart beat may involve such artifacts. If the patient heart rate allows to use data from different heart cycles, it may be advantageous to actually use data of different heart cycles, wherein the danger of motion artifacts are taken into account according to the invention.

Secondly, artifacts may occur when the first projection of a cardiac weighting vector is a c-partner (or essentially a π-partner) of the last projection in the next or the previous cardiac weighting vector. When the end of a previous packet of used data related to a previous heart beat relates to an angular position of the rotating source/detector with respect to the heart which differs from an angular position of the rotating source/detector at the beginning of a subsequent packet of data related to a subsequent heart beat by π (i.e. 180°), 2π (i.e. 360°), 3π (i.e. 540°), then the reconstruction is prone to artifacts.

Thirdly, artifacts may appear when the motion state of the heart differs significantly in these projection (that is in the projections related to the used/selected data). Such differences in the motion state may be due to the heart beat or due to the patient's motion during the detection of data.

The invention considers the recognition of these three criteria during the analysis of multi-cycle cardiac computer tomography data which are prone to artifacts. In case that all three criteria are fulfilled so that there is the danger of artifacts, then the cardiac weighting functions are re-calculated to remove the danger of artifacts.

The above-mentioned conditions 1 and 3 are mainly imposed by the patient's physiology and its heart beat characteristics (e.g. the heart beat rate). Thus, these conditions can usually not be adjusted by an operator selecting projections from a huge amount of multi-cycle cardiac computer tomography data for a subsequent analysis. According to an exemplary embodiment of the invention, the above-mentioned conditions 1 and 3 may be detected, and if conditions 1 and 3 are fulfilled, then it is ensured that condition 2 is not fulfilled, particularly by modifying cardiac weighting functions in such a manner as to enforce a violation of condition 2.

Condition 1 is usually simple to detect, because it essentially depends on the scanner rotation time, the pitch and the patient's heart beat rate only. The scanner rotation time is the time which the X-ray source and the detector mounted on a gantry rotate around the heart under investigation. The patient's heart beat rate relates to the number of beats of a patient's heart per time. The pitch depends on the table travel per rotation (and may be defined, for instance, as the table travel per rotation divided by the X-ray beam width, or may be defined as the ratio between the table travel per rotation and the detector width).

Referring to the other conditions, the cardiac gating vectors may be first calculated in a usual way (for instance in a similar manner as disclosed by the above-mentioned reference Grass et al.). Subsequently, it may be checked whether condition 2 is fulfilled for this calculated cardiac weighting function. If this is the case, then the motion states may be compared on the basis of the view data which are measured redundantly (see also FIG. 5). In order to force a violation of condition 2, the cardiac weighting function may be re-calculated.

The above-mentioned three conditions which have to be fulfilled simultaneously such that undesired artifacts occur, will be described again in the following:

The first condition is related to the fact whether multi-cycle reconstruction can be carried out (which is usually desired in order to obtain a proper resolution). In cardiac CT, it is usually advantageous to capture at least data which relate to an angle of 180° of a rotation circle of detector and X-ray source around the heart. In a multi-cycle reconstruction, the required data are mixed from data of different beating cycles of the heart. Since the data from the different beating cycles of the heart may relate to different motion states of the heart, this procedure can generate artifacts in the reconstructed image.

Referring to the second condition mentioned above, the data may be captured by a an X-ray source and a detector rotating in a helical manner around the heart. For each heart cycle, a part of the corresponding detected projections may be selected for the reconstruction of the image. In case that adjacent portions of used data of different heart cycles relate to particular angular positions of source/detector with respect to the heart, the corresponding cardiac weighting function may produce artifacts. By modifying the projections used for the reconstruction in a manner that π-partners of adjacent projections used from different heart cycles are avoided, these artifacts may be eliminated.

Referring to the above-mentioned third condition, when the motion state of the heart is very different for different projections used, motion artifacts may occur.

In contrast to parameters 1 and 3 being essentially defined by the patient, parameter 2 can be adjusted, since this parameter can be set retrospectively when analyzing the data and when selecting data for the actual reconstruction.

In case that conditions 1 and 3 are not fulfilled, there is usually no danger of artifacts. In case that conditions 1 and 3 are simultaneously fulfilled, then the parameter 2 can be adjusted to suppress artifacts. Particularly, this adjustment can be carried out by adjusting the width of the distribution functions of the cardiac weighting function. Further, the shape of the cardiac weighting function can be adjusted, for instance parameters according to a cosine square function, to a triangle function, to a step function or to a Gaussian can be set.

Such an adjustment can include an adjustment of the distance between the zero points of subsequent non-zero portions of the weighting function. Further, such an adjustment may include the adjustment of the weighting function shape itself. A weighting function distribution related to a particular heartbeat should be mathematically continuously at the borders where the distribution function has its zero points. Generally, the weighting function has a value of zero when assigned data are not used for the reconstruction, and has a value different from zero when the assigned data are used for the reconstruction.

In the following, further exemplary embodiments of the invention will be described.

Next, embodiments for the device according to the invention will be described. However, these embodiments apply also for the method for analyzing multi-cycle cardiac computer tomography data, for the computer tomography apparatus, for the computer-readable medium and for the program element.

The first determining unit of the device may be adapted to determine a cardiac weighting function including contributions from a plurality of heart cycles, wherein each of the contributions may be described by a distribution function having two zero points at the borders. In other words, when illustrating subsequent heart cycles along an axis, the entire weighting function may include a plurality of single distribution functions, wherein each distribution function relates to a particular heart phase (see also FIG. 3A, FIG. 3B). Between the various distribution functions, the weighting function has the value zero. In this manner, packets of used data related to different heart cycles are defined.

The first determining unit of the device may further be adapted to determine the distribution functions to be continuous at the two zero points. At the border of a particular heart cycle, the distribution function advantageously goes smoothly to zero so that a distribution between two zero points is obtained, in order to further suppress artifacts.

Moreover, the first determining unit may be adapted to determine the distribution functions as one of the group consisting of a square of a cosine function, a triangle function, a step function (a rectangular function) and a Gaussian. However, other distribution functions are possible, for instance a Lorentzian, a multi-step function, or the like. The distribution functions may be normalized (e.g. such that the area under the distribution function is unity).

The device according to the invention may further comprise an investigating unit adapted to investigate whether a reconstruction of the image of the heart is performable using detected cardiac computer tomography data originating from different cycles of the heart. In other words, before determining cardiac weighting functions or modified cardiac weighting functions, the investigation unit may first determine or investigate whether the present experimental and physiological frame conditions are appropriate to reconstruct an image of the heart using acquired data related to different heart phases.

In particular, the investigating unit may be adapted to investigate whether a reconstruction of the image of the heart is performable using detected cardiac computer tomography data originating from different cycles of the heart based on at least one of the criteria of the group consisting of a beat rate of the heart, a pitch of a computer tomography apparatus and a rotation time of a gantry of a computer tomography apparatus. These parameters are meaningful with respect to the question whether the experimental frame conditions and the physiology of the patient allow a multi-cycle reconstruction.

The device may comprise a second determining unit adapted to determine whether, for the determined cardiac weighting function, variations of the motion state of the heart related to computer tomography data included in the determined cardiac weighting function exceed a motion threshold. If the motion of the heart is too strong, then motion artifacts can occur when using projections related to very different motion states of the heart.

The modifying unit may be adapted to modify the cardiac weighting function only in case that the motion threshold is exceeded. In other words, the second determination unit may detect whether the motion is that strong that a modification of the weighting function is really necessary to avoid artifacts. If this is not the case, it may be dispensable to calculate a modified weighting function.

The second determining unit may adapted to determine the motion threshold based on at least one of the criteria of the group consisting of a beat rate of the heart and a rotation time of a gantry of a computer tomography apparatus. In other words, particular the relation between the heartbeat rate and the rotation time of a gantry is meaningful for the question whether the motion state of the heart differs significantly in different projections so that the occurrence of artifacts can not be ruled out. Another meaningful criteria is the extent to which a patient moves on an examination table during the detection of data.

The modifying unit of the device may be adapted to modify the cardiac weighting function by modifying the distribution functions. In particular, the modifying unit may be adapted to modify the cardiac weighting function by modifying the distance between adjacent zero points of adjacent distribution function. Moreover, the modifying unit may be adapted to modify the cardiac weighting functions by modifying a width of at least one of the distribution functions, for instance a full width half maximum (FWHM).

According to an exemplary embodiment of the invention, the modifying unit may be adapted to modify the cardiac weighting function in such a manner that it is avoided that at least two adjacent zero points of at least two adjacent distribution functions are assigned to projections related to positions of a rotating detector detecting the X-rays attenuated by the heart and the thorax which positions essentially differ by an integer multiple of 180°. In other words, the modifying unit may be adapted to modify the cardiac weighting function to prevent adjacent zero points of adjacent distribution functions from being assigned to projections differing by essentially 180°, 360°, 540°, . . . (that is by a multiple of 180° or π). In other words, if the first projection in a cardiac weighting vector is a π-partner (or almost a π-partner) of the last projection in the next or the previous cardiac weighting vector, there is the danger of artifacts. When the angular position of the detector rotating on a gantry around the heart differs by n·π (wherein n is an integer number) at the end zero point of a preceding distribution function compared to a start zero point of a subsequent distribution function, then there is a danger of artifacts.

According to an exemplary embodiment of the invention, the device may be adapted to analyze multi-cycle cardiac computer tomography data under consideration of electrocardiogram data of the heart detected simultaneously with the detection of the multi-cycle cardiac computer tomography apparatus. In other words, an electrocardiogram measured simultaneously with the measurement of the cardiac computer tomography data may deliver important and complementary information for determining whether there is the danger of (motion) artifacts.

The device may be adapted such that the predefined overlap threshold is in the range between 5 degrees and 90 degrees (5° to 90°), preferably in the range between 30 degrees and 50 degrees (30° to 50°). These ranges for values of the overlap threshold are particularly advantageous and allow an effective suppression of motion artifacts. In general one may state that the influence of motion artifacts is rather weak in a scenario in which the overlap is relatively large.

In the following, exemplary embodiments of the computer tomography apparatus will be described. However, these embodiments also apply for the device and the method for analyzing multi-cycle cardiac computer tomography data, for the computer-readable medium and for the program element.

The X-ray source and the detecting elements of the computer tomography apparatus may be adapted to rotate according to a helical trajectory. This may achieved by a circularly rotating gantry (on which source and detector may be mounted) in combination with a linear motion of the heart under investigation, for instance by linearly moving a mounting table onto which a patient is located.

Particularly in the frame of a multi-slice detector, a helical trajectory may be replaced by a circular trajectory.

The computer tomography apparatus may further comprise a collimator arranged between the X-ray source and the detecting elements, the collimator being adapted to collimate an X-ray beam emitted by the X-ray source to form a fan-beam or a cone-beam. The invention is primarily directed to a cone-beam configuration. However, the invention may also be applied to a fan-beam configuration.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

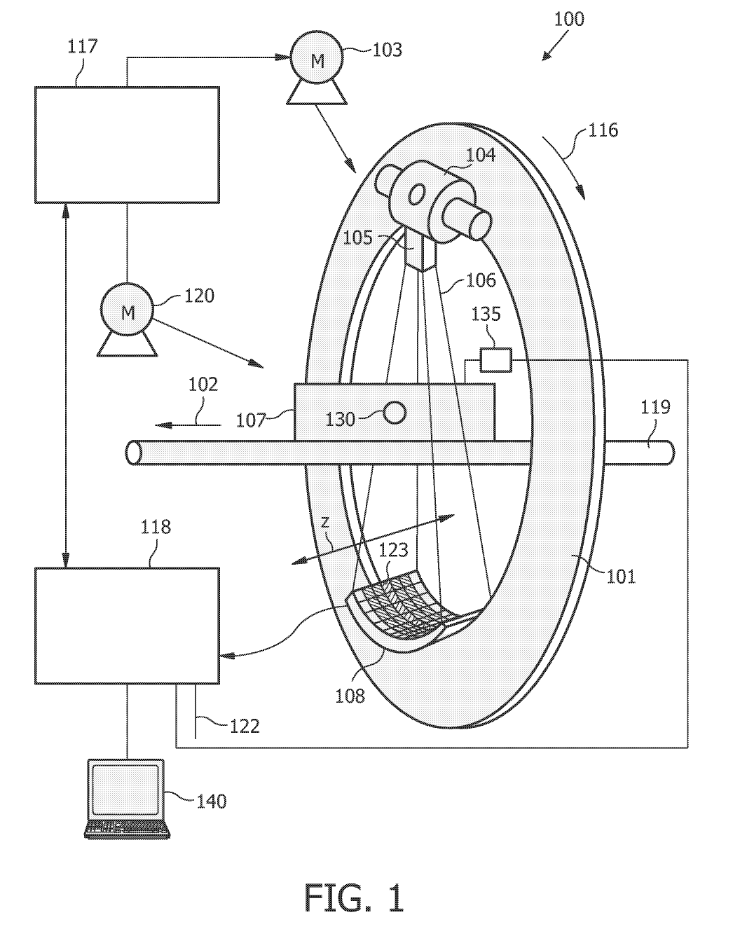

FIG. 1 shows a computer tomography apparatus according to an exemplary embodiment of the invention,

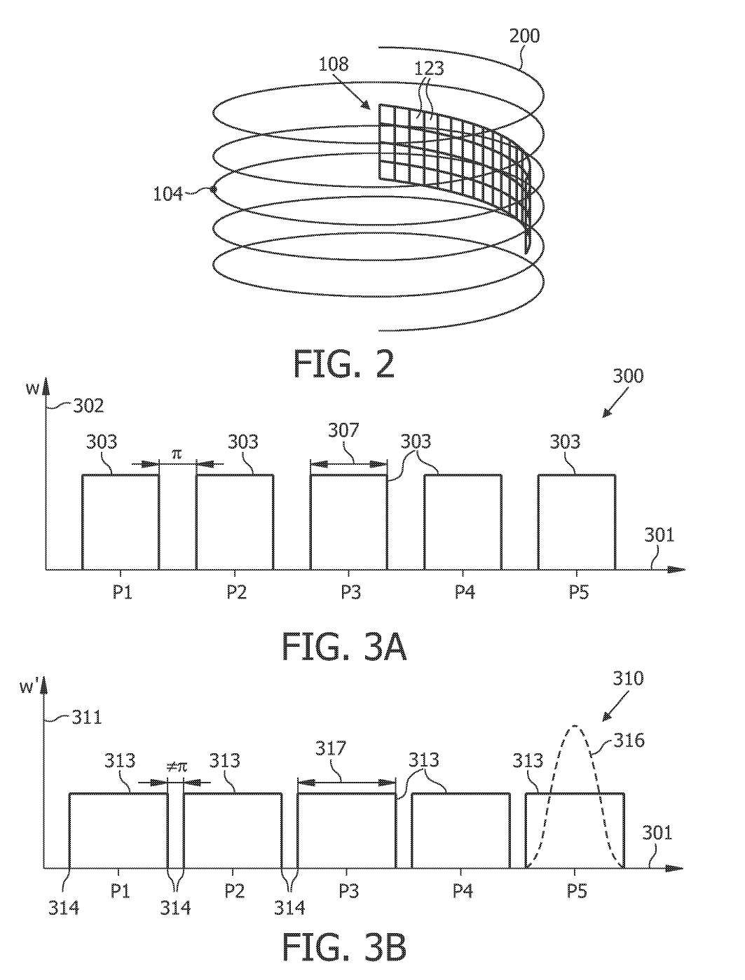

FIG. 2 shows a trajectory of a helical scan for capturing multi-cycle cardiac computer tomography data,

FIG. 3A shows a schematic diagram illustrating weighting functions for projections related to subsequent heart cycles,

FIG. 3B shows a schematic diagram illustrating modified weighting functions for projections related to subsequent heart cycles, wherein artifacts are suppressed,

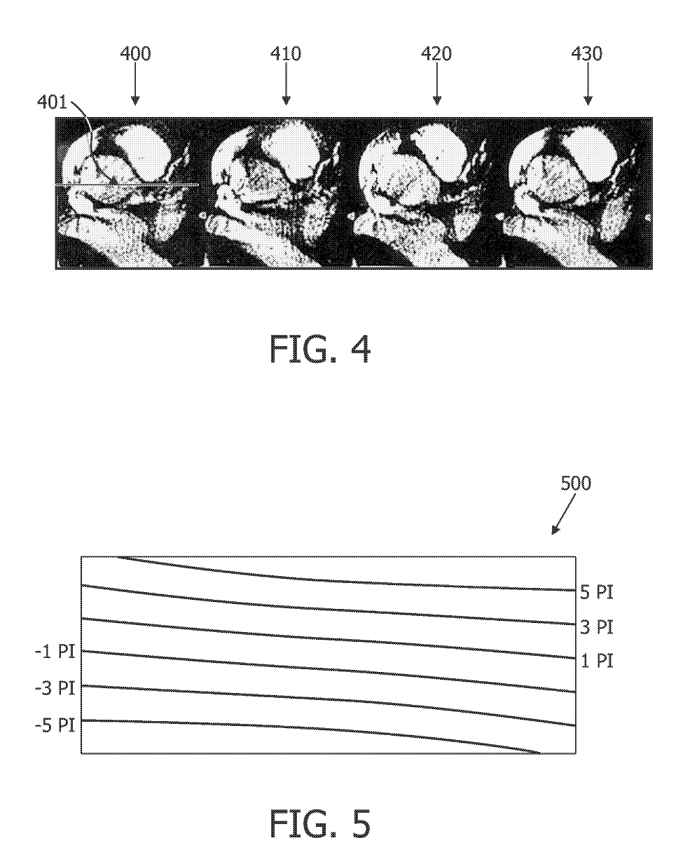

FIG. 4 shows reconstruction images of a heart reconstructed without and with the artifacts suppressing scheme according to the invention,

FIG. 5 shows the projection of the source trajectory onto a WEDGE detector,

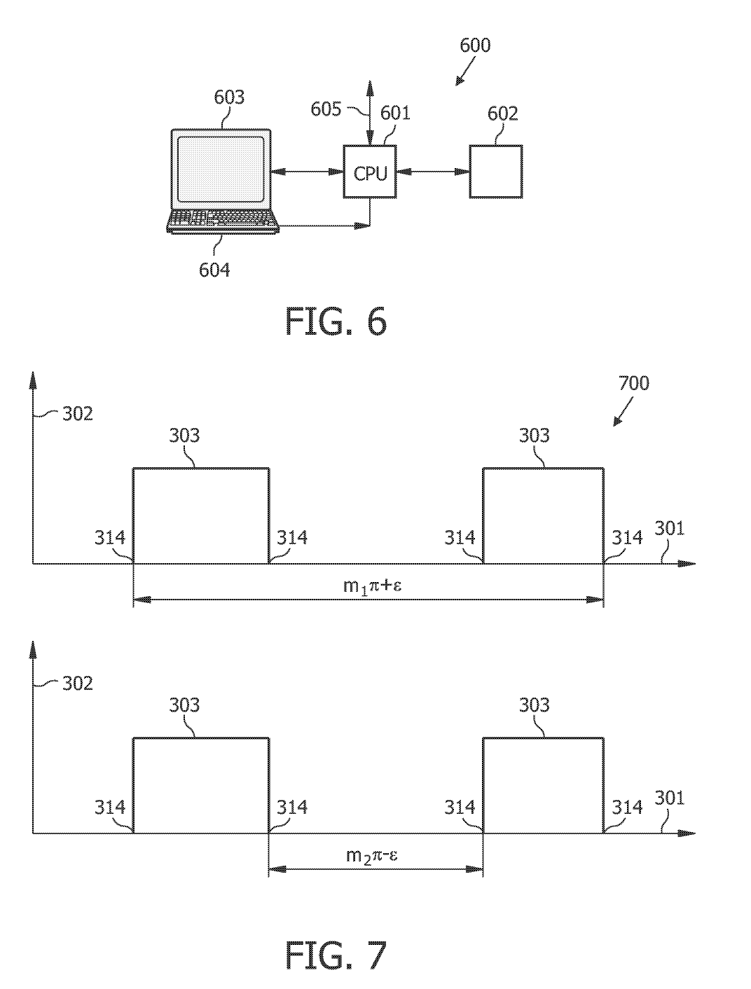

FIG. 6 shows an exemplary embodiment of a data processing device to be implemented in the computer tomography apparatus of the invention,

FIG. 7 shows another schematic diagram illustrating weighting functions for projections related to subsequent heart cycles.

The illustration in the drawings is schematically. In different drawings, similar or identical elements are provided with the same reference signs.

FIG. 1 shows an exemplary embodiment of a computed tomography scanner system according to the present invention.

The computer tomography apparatus 100 depicted in FIG. 1 is a cone-beam CT scanner. However, the invention may also be carried out with a fan-beam geometry. The CT scanner depicted in FIG. 1 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 1, the detector 108 is arranged on the gantry 101 opposite to the source of radiation 104, such that the surface of the detector 108 is covered by the cone beam 106. The detector 108 depicted in FIG. 1 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a control unit 118 (which might also be denoted as a calculation or determination unit).

In FIG. 1, the object of interest 107 is a human being which is disposed on an operation table 119. During the scan of a heart 130 of the human being 107, while the gantry 101 rotates around the human being 107, the operation table 119 displaces the human being 107 along a direction parallel to the rotational axis 102 of the gantry 101. By this, the heart 130 is scanned along a helical scan path. The operation table 119 may also be stopped during the scans to thereby measure signal slices. It should be noted that in all of the described cases it is also possible to perform a circular scan, where there is no displacement in a direction parallel to the rotational axis 102, but only the rotation of the gantry 101 around the rotational axis 102.

Moreover, an electrocardiogram device 135 is provided which measures an electrocardiogram of the heart 130 of the human being 107 while X-rays attenuated by passing the heart 130 are detected by detector 108. The data related to the measured electrocardiogram are transmitted to the control unit 118.

Further, it shall be emphasized that, as an alternative to the cone-beam configuration shown in FIG. 1, the invention can be realized by a fan-beam configuration. In order to generate a primary fan-beam, the aperture system 105 can be configured as a slit collimator.

The detector 108 is connected to the control unit 118. The control unit 118 receives the detection result, i.e. the read-outs from the detector elements 123 of the detector 108 and determines a scanning result on the basis of these read-outs. Furthermore, the control unit 118 communicates with the motor control unit 117 in order to coordinate the movement of the gantry 101 with motors 103 and 120 with the operation table 11.

The control unit 118 may be adapted for reconstructing an image from read-outs of the detector 108. A reconstructed image generated by the control unit 118 may be output to a display (not shown in FIG. 1) via an interface 122.

The control unit 118 may be realized by a data processor to process read-outs from the detector elements 123 of the detector 108.

The computer tomography apparatus shown in FIG. 1 captures multi-cycle cardiac computer tomography data of the heart 130. In other words, when the gantry 101 rotates and when the operation table 119 is shifted linearly, then a helical scan is performed by the X-ray source 104 and the detector 108 with respect to the heart 130. During this helical scan, the heart 130 may beat a plurality of times. During these beats, a plurality of cardiac computer tomography data are acquired. Simultaneously, an electrocardiogram is measured by the electrocardiogram unit 135. After having acquired these data, the data are transferred to the control unit 118, and the measured data may be analyzed retrospectively.

The measured data, namely the cardiac computer tomography data and the electrocardiogram data are processed by the control unit 118 which may be further controlled via a graphical user-interface (GUI) 140. This retrospective analysis is based on a helical cardiac cone beam reconstruction scheme using retrospective ECR gating as disclosed in the above-mentioned reference Grass et al. 2003.

However, in addition to the conventional ECR scheme, the device 118 is adapted to analyze the multi-cycle cardiac computer tomography data detected by attenuating X-rays passing the heart 113 in the following manner, to eliminate artifacts: An investigating unit of the device 118 investigates whether a reconstruction of the image of the heart 130 is performable using detected cardiac computer tomography data originating from different beating cycles of the heart 130. This investigating unit checks whether the patient's heart rate allows for a multi-cycle reconstruction. If this is the case, then a multi-cycle reconstruction algorithm is carried out, as will be explained in the following.

A first determining unit of the device 118 is adapted to determine, based on the detected computer tomography data, a cardiac weighting function for a reconstruction of an image of the heart 130. Such a cardiac weighting function determines which of the cardiac computer tomography data are selected for a further analysis. A second determining unit of the device 118 is adapted to determine whether, for the determined cardiac weighting function, variations of the motion state of the heart related to computer tomography data included in the determined cardiac weighting function exceed a threshold value. That is to say, the second determining unit checks whether the motion state of the heart 130 differs significantly in the different projections which shall be used for the subsequent analysis. If the variation of the motion state of the heart is lower than the threshold, then there is no substantial danger for the occurrence of artifacts. However, in case that the motion state of the heart differs significantly in different projections, then the danger of artifacts has to be considered and removed as described in the following.

If such a danger of artifacts exists, then a modifying unit of the device 118 modifies the cardiac weighting function in such a manner that an overlap of succeeding distribution functions of the weighting function, which distribution functions are assigned to different cycles of the heart 130, is at least equal to a predefined overlap threshold. In other words, the modifying unit modifies or rearranges the data block and/or their weighting factors which are used subsequently for reconstructing the image of the heart. This new selection or update/refinement of the previous selection removes artifacts from a reconstructed image.

FIG. 2 shows a schematic view of the X-ray source 104 and of the multi-slice detector 108 as well as of the helical trajectory 200 along which the X-ray source 104 and the detector 102 move with respect to the heart (not shown in FIG. 2, but being arranged in the center of the trajectory 200). During this helical scan along the trajectory 200, the heart 130 beats a plurality of times.

FIG. 3A shows a diagram 300 illustrating along an abscissa 301 the acquisition time or the projection number of cardiac computer tomography data acquired. Along an ordinate 302, a weighting function was determined by the first determining unit of the device 118 is shown. The points denoted along the abscissa 301 as P1, P2, P3, P4, are related to five subsequent beat cycles of the heart 130. The weighting functions w have the meaning that a rectangular portion around each of the centers of the heartbeats P1 to P5 are used as data for the subsequent reconstruction of the image of the heart 130. Data/projections between the rectangular portions around P1 to P5 are not used for this analysis.

However, since the distance between the right border of the weighting function related to the first heart beat P1 and the left border of the weighting function related to the second heart beat P2 have a distance of π or 180°, the first projection in the cardiac weighting vector is a so-called π-partner of the last projection in the next cardiac weighting function vector. Thus, the weighting vectors w estimated by the first determining unit are prone to artifacts.

FIG. 3B shows a diagram 310 having an abscissa 301 along which, again, the acquisition time or projection number is plotted, and the heartbeat cycles P1 to P5 are also shown in FIG. 3B. Along an ordinate 311 of the diagram 310, a modified weighting function w′ is shown, in which the different distribution functions 303 related to the different heart cycles P1 to P5 are modified compared to the weighting function w. The modified distribution functions are denoted with reference number 313. Since the distance between the right border of the distribution function 313 related to the first heart cycle P1 and the left border of the distribution function 313 related to the second heart cycle P2 is different from π, artifacts in the reconstructed image may be suppressed. In particular, whereas the cardiac weighting function w is such that variations of the motion state of the heart related to computer tomography data included in the determined cardiac weighting functions exceed a threshold, the modified weighting function w′ is selected in such a manner that the overlap of the weighting vectors is at least a certain value e (overlap threshold), which can be pre-defined (for example in the order of 10-50 degrees).

The distribution functions 313 each are non-zero between two zero points 314. Although, for the purpose of illustration, the distribution functions 303, 313 are shown as rectangular functions, it is more preferred to use a square of a cosine function being continuous at the two zero points 314 as weighting functions w or w′. This is illustrated in FIG. 3B and denoted with reference sign 316.

The modifying unit of the device 118 modifies the cardiac weighting function from w to w′ by modifying the distribution function 303 to become the distribution function 313, wherein the distance between adjacent zero points 314 of adjacent distribution functions 313, 303 is changed. Particularly, the width 317 of the modified weighting function w′ is changed with respect to a width 307 of the weighting function w.

FIG. 4 illustrates different images 400, 410, 420, 430. From these images 400, 410, 420, 430, one can gather that the scheme according to the invention is capable of reducing artifacts. FIG. 4 shows different reconstructions using ECR (extended cardiac reconstruction).

Image 400 shows a standard three-cycle reconstruction image with temporal optimization showing blocking artifacts (particularly a horizontal line 401 in the center of the image). Image 410 shows a single cycle reconstruction from a phase 1. Image 420 shows a single-cycle reconstruction from a phase point 2. Finally, image 430 reconstructed according to the scheme according to the invention related to a three-cycle reconstruction using an overlap of at least 48°.

FIG. 5 shows a diagram 500 illustrating how, according to the invention, it is checked whether the above-mentioned condition 3 is fulfilled. If this is namely the case, then the motion states are compared on the basis of the view data which are measured redundantly. This is what is illustrated in FIG. 5. FIG. 5 shows the projection of the source trajectory onto a WEDGE detector. Some line integrals are measured truly twice, namely the line integrals which contain two points on the helix. For instance, if two views are 3π apart, then the data on the line with label “3π” in one view corresponds to data on the line with label “−3π” in the other view. The difference of the line integrals along these lines can be used to detect the above-mentioned condition 3. If condition 3 is fulfilled, then the cardiac weighting vectors are broadened in order to enforce a violation of condition 2, which will result in an artifact free image, as shown in image 430 of FIG. 4.

FIG. 6 depicts an exemplary embodiment of a data processing device 600 according to the present invention for executing an exemplary embodiment of a method in accordance with the present invention. The data processing device 600 depicted in FIG. 6 comprises a central processing unit (CPU) or image processor 601 connected to a memory 602 for storing an image depicting an object of interest, such as a heart of a patient. The data processor 601 may be connected to a plurality of input/output network or diagnosis devices, such as a CT device. The data processor 601 may furthermore be connected to a display device 603, for example a computer monitor, for displaying information or an image computed or adapted in the data processor 601. An operator or user may interact with the data processor 601 via a keyboard 604 and/or other output devices, which are not depicted in FIG. 6. Furthermore, via the bus system 605, it is also possible to connect the image processing and control processor 601 to, for example a motion monitor, which monitors a motion of the object of interest. In case the heart is imaged, the motion sensor may be an electrocardiogram (ECG).

In the following, referring to FIG. 7, another schematic diagram 700 illustrating weighting functions for projections related to subsequent heart cycles will be described.

The diagram 700 illustrates (in a similar manner like in FIG. 3A, FIG. 3B) along an abscissa 301 a projection angle related to different projections measured during a helical CT scan for examining a beating heart. Along an ordinate 302, a weighting function is plotted indicating which of the acquired projections are actually used for a subsequent detailed analysis. FIG. 7 shows two distribution functions 303 (also denoted as weighting vectors, which form a set of selected projections) which are related to two subsequent beats of the heart under investigation. Each of the weighting vectors 303 is shown schematically and can be, for instance, realized as a square of a cosine having non-zero-values between two limiting zero values 314. The distance between the left border of the left weighting vector 303 and the right border of the right weighting vector 303 is m₁ ·π+ε, wherein m₁ is an integer and ε is the so-called “overlap”. The distance between the right border of the left weighting vector 303 and the left border of the right weighting vector 303 is m₂·π−ε, wherein m₂ is an integer. The parameters m₁ and m₂ are by definition chosen such that 0≦ε<π.

According to the invention, an initially calculated cardiac weighting function 302 may be modified so that an overlap ε of succeeding weighting vectors 303 of the weighting function 302 is larger than or equal to a predefined overlap threshold. The distribution functions 303 are assigned to different cycles of the heart. Thus, the weighting function defines which projections will be used for the reconstruction of the image of the heart. When data from different heart cycles are used, then the weighting function 302 can be divided into a plurality of weighting vectors 303, wherein each of the weighting vectors 303 defines a distribution function determining which data related to an assigned heart cycle are selected for further analysis. As shown in FIG. 7, an “overlap” ε of weighting vectors 303 is a value which defines the distances between limits 314 of adjacent weighting vectors 303. When the overlap c is selected large enough, then artifacts are efficiently suppressed.

Exemplary technical fields, in which the present invention may be applied advantageously, include medical applications, material testing, and material science. An improved image quality and a reduced amount of calculations in combination with a low effort may be achieved. Particularly, the invention can be applied in the field of heart scanning to detect heart diseases.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A device for analyzing multi-cycle cardiac computer tomography data detected by attenuating X-rays by a heart, wherein the device comprises:
a first determining unit adapted to determine, based on the detected computer tomography data, a cardiac weighting function for a reconstruction of an image of the heart;
a modifying unit adapted to modify the cardiac weighting function in such a manner that an overlap of succeeding distribution functions of the weighting function, which distribution functions are assigned to different cycles of the heart, is at least equal to a predefined overlap threshold.

2. The device according to claim 1, wherein the first determining unit is adapted to determine the cardiac weighting function including contributions from a plurality of heart cycles, wherein each of the contributions is described by one of the distribution functions which is limited by two zero points.

3. The device according to claim 2, wherein the first determining unit is adapted to determine the distribution functions to be continuous at the two zero points.

4. The device according to claim 2, wherein the first determining unit is adapted to determine the distribution functions as one of the group consisting of a triangle function, a step function, a Gaussian distribution and a square of a cosine function.

5. The device according to claim 1, further comprising an investigating unit adapted to investigate whether a reconstruction of the image of the heart is performable using detected cardiac computer tomography data originating from different cycles of the heart.

6. The device according to claim 5, wherein the investigating unit is adapted to investigate whether a reconstruction of the image of the heart is performable using detected cardiac computer tomography data originating from different cycles of the heart based on at least one of the criteria of the group consisting of a beat rate of the heart, a pitch of a computer tomography apparatus and a rotation time of a gantry of a computer tomography apparatus.

7. The device according to claim 1, further comprising a second determining unit adapted to determine whether, for the determined cardiac weighting function, variations of the motion state of the heart related to computer tomography data included in the determined cardiac weighting function exceed a motion threshold;

8. The device according to claim 7, wherein the modifying unit is adapted to modify the cardiac weighting function only in case that the motion threshold is exceeded.

9. The device according to claim 7, wherein the second determining unit is adapted to determine the motion threshold based on at least one of the criteria of the group consisting of a beat rate of the heart and a rotation time of a gantry of a computer tomography apparatus.

10. The device according to claim 1, wherein the modifying unit is adapted to modify the cardiac weighting function by modifying at least one of the distribution functions.

11. The device according to claim 2, wherein the modifying unit is adapted to modify the cardiac weighting function by modifying the distance between at least two adjacent zero points of at least two adjacent distribution functions.

12. The device according to claim 1, wherein the modifying unit is adapted to modify the cardiac weighting function by modifying a width of at least one of the distribution functions.

13. The device according to claim 2, wherein the modifying unit is adapted to modify the cardiac weighting function in such a manner that it is avoided that at least two adjacent zero points of at least two adjacent distribution functions are assigned to projections related to positions of a rotating detector detecting the X-rays attenuated by a heart which positions essentially differ by an integer multiple of 180°.

14. The device according to claim 1, adapted to analyze the multi-cycle cardiac computer tomography data under consideration of electrocardiogram data of the heart detected simultaneously with the detection of the multi-cycle cardiac computer tomography data.

15. The device according to claim 1, wherein the predefined overlap threshold is in the range between 5 degrees and 90 degrees, preferably in the range between 30 degrees and 50 degrees.

16. A computer tomography apparatus, comprising an X-ray source adapted to emit X-rays to a heart and adapted to rotate around the heart;
detecting elements adapted to rotate around the heart and adapted to detect multi-cycle cardiac computer tomography data by detecting X-rays emitted by the X-ray source and attenuated by the heart; and
a device according to claim 1 for analyzing the detected multi-cycle cardiac computer tomography data.

17. The computer tomography apparatus according to claim 16, wherein the X-ray source and the detecting elements are adapted to rotate according to a helical trajectory with respect to the heart.

18. The computer tomography apparatus according to claim 16, comprising a collimator arranged between the X-ray source and the detecting elements, wherein the collimator is adapted to collimate an X-ray beam emitted by the X-ray source to form a fan-beam or a cone-beam.

19. A method of analyzing multi-cycle cardiac computer tomography data detected by attenuating X-rays by a heart, wherein the method comprises the steps of:
determining, based on the detected computer tomography data, a cardiac weighting function for a reconstruction of an image of the heart;
modifying the cardiac weighting function in such a manner that an overlap of succeeding distribution functions of the weighting function, which distribution functions are assigned to different cycles of the heart, is at least equal to a predefined overlap threshold.

20. A computer-readable medium, in which a computer program of analyzing multi-cycle cardiac computer tomography data detected by attenuating X-rays by a heart is stored which, when being executed by a processor, is adapted to carry out the steps of:
determining, based on the detected computer tomography data, a cardiac weighting function for a reconstruction of an image of the heart;
modifying the cardiac weighting function in such a manner that an overlap of succeeding distribution functions of the weighting function, which distribution functions are assigned to different cycles of the heart, is at least equal to a predefined overlap threshold.

21. A program element of analyzing multi-cycle cardiac computer tomography data detected by attenuating X-rays by a heart, which, when being executed by a processor, is adapted to carry out the steps of:
determining, based on the detected computer tomography data, a cardiac weighting function for a reconstruction of an image of the heart;
modifying the cardiac weighting function in such a manner that an overlap of succeeding distribution functions of the weighting function, which distribution functions are assigned to different cycles of the heart, is at least equal to a predefined overlap threshold.
